(19) United States
(12) Patent Application Publication
(10) Pub. No.: US 2008/0172411 A1
(43) Pub. Date: Jul. 17, 2008

(54) OBJECT DATA PROCESSING METHOD AND APPARATUS

(75) Inventor: Toru Kikuchi, Hino-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/965,316

(22) Filed: Dec. 27, 2007

(30) Foreign Application Priority Data
Jan. 12, 2007 (JP) 2007-005082

(51) Int. Cl. G06F 17/30

(52) U.S. Cl. 707/103 X; 707/E17.055

(57) ABSTRACT

An apparatus that process an object data that exists in a network searches within the network for a second object data that corresponds to a first object data and to which a predetermined data has been added, and changes or deletes the second object data in response to a change in, or a deletion of, the first object data.

### BACKGROUND OF THE INVENTION

1. Field of the Invention

The present invention relates to a processing method and an apparatus that processes an object data that is present on a network.

2. Description of the Related Art

Recent years have seen an increasing need for connecting, via a network, such household appliance products as a camera, a video camera, an audio system, a video recorder, or a television, and use, in a mutually interchangeable manner, such content as a graphic image data, a video data, or an audio data.

For example, a need exists to view the content within a digital camera or a digital video camera on a television screen and perform such an operation as copying the content therefrom to the video recorder without mediating the operation via a personal computer (PC). Another increasing need is to ensure mutual connectivity among hardware from a plurality of vendors.

An industry body known as the Digital Living Network Alliance (DLNA), founded in response to such needs as the preceding, presents a variety of guidelines for ensuring mutual connectivity. DLNA administrates a stored data via a function known as a content directory service (CDS), and accesses the stored data via function known as a control point (CP). With regard to the CDS, the stored data is referred to as an item, a device that corresponds to a folder is referred to as a container, and the item and the container are collectively referred to as an object.

On the other hand, for example, another increasing need is to view the content in an environment wherein the hardware may be powered on or off, or be taken out of doors, as well as a need to avoid losing the content when the hardware suffers a fault.

A user thus typically stores a content with a high degree of importance in a plurality of memory media, and performs a manual content administration operation that takes a synchronization as necessary. The administration becomes troublesome as the content increases in volume, however.

A related PC-centric technology exists that is known as a Redundant Array of Independent Disks (RAID), which records a data with redundancy on a hard disk drive; refer to the Adaptec website for further information.

A backup method exists for setting a frequency of backing up a file according to the importance of the file, making the backup process more efficient, and reducing the load thereof; refer to Japanese Patent Laid-Open No. 06-250902 for further information. According to the method thereof, a system is configured with a file administration table installed in a server memory, and to be capable of setting, on a per file basis, an update counter that records a number of update iterations of the file and an update regulation iteration for backing up the file according to the importance of the file.

The RAID is not capable of administrating a mirroring or the backup on a per content basis, however, because the RAID duplexes the hard disk drive therein. The hardware also requires a function that duplexes a writing of the content to the disk, and thus cannot be applied to the content administration with regard to a typical DLNA-compliant hardware.

According to the technology disclosed in Japanese Patent Laid-Open No. 06-250902 that administrates the backup by installing the file administration table on the server, it is possible to administrate the backup on a per file basis. If the server that contains the file administration table is powered off, however, it becomes impossible to use the administration information and to access the backed-up file. While it would be conceivable to maintain the file administration table on a plurality of servers or terminals, it would be impossible to ensure consistency of the file administration table that is maintained on the plurality of servers in an environment wherein each respective device is not powered on and off in synchrony with the other device, thus giving rise to a discrepancy therebetween.

Presume, for example, a situation wherein are present a server 1 and a server 2 that possess the file administration table, with a file administration operation of reading from, writing to, updating, and deleting the file, and the file administration table being overwritten, with the server 1 powered off. If, in such a situation, the server 2 is powered off, and the server 1 powered on thereafter, the file administration table of the server 1 will not be updated to the latest status, giving rise to a discrepancy between the file administration table of the server 1 and the server 2.

### SUMMARY OF THE INVENTION

According to an exemplary embodiment of the present invention, a method and an apparatus are provided that allow improving a reliability of a synchronization of an object data.

According to one aspect of the present invention, there is provided a method adapted to processing an object data that is present within a network, comprising the steps of: searching, within the object data that is present within the network, for a second object data that corresponds to a first object data and whereto a predetermined data has been added; and changing the second object data in response to a change on the first object data.

Also, according to another aspect of the present invention, there is provided an apparatus for processing an object data that is present within a network, comprising: a unit configured to search, within the object data that is present within the network, for a second object data that corresponds to a first object data and whereto a predetermined data has been added; and a unit configured to change the second object data in response to a change on the first object data.

Further features of the present invention will become apparent from the following description of exemplary embodiments, with reference to the attached drawings.

### BRIEF DESCRIPTION OF THE DRAWINGS

FIG. 1 depicts a system configuration example according to an embodiment.

FIG. 2 is a block diagram depicting a hardware configuration example of a display apparatus according to the embodiment.

FIG. 3 is a block diagram describing a function configuration of a unified administration control point according to a first embodiment.

FIGS. 4A-4C depict an example of a metadata of an object according to the first embodiment.

FIG. 5 is a flowchart depicting a main process of the unified administration control point according to the embodiment.

FIG. 6 is a flowchart depicting an administration object generation process according to the first embodiment.

FIG. 7 is a flowchart depicting a read process according to the embodiment.

FIG. 8 is a flowchart depicting a write process according to the embodiment.

FIG. 9 is a flowchart depicting a delete process according to the embodiment.

FIG. 10 is a flowchart depicting an update process according to the embodiment.

FIG. 11 is a block diagram describing a function configuration of a unified administration control point according to a second embodiment.

FIGS. 12A-12C depict an example of an object metadata according to the second embodiment.

FIG. 13 is a flowchart depicting an administration object generation process according to the second embodiment.

FIG. 14 is a block diagram describing a function configuration of a unified administration control point according to a third embodiment.

FIGS. 15A-15C depict an example of an object metadata according to the third embodiment.

FIG. 16 is a flowchart depicting an administration object generation process according to the third embodiment.

FIGS. 17A and 17B depict an example of an administration operation user interface screen according to the embodiment.

### DESCRIPTION OF THE EMBODIMENTS

Following is a detailed description of embodiments of the present invention, with reference to the attached drawings.

### First Embodiment

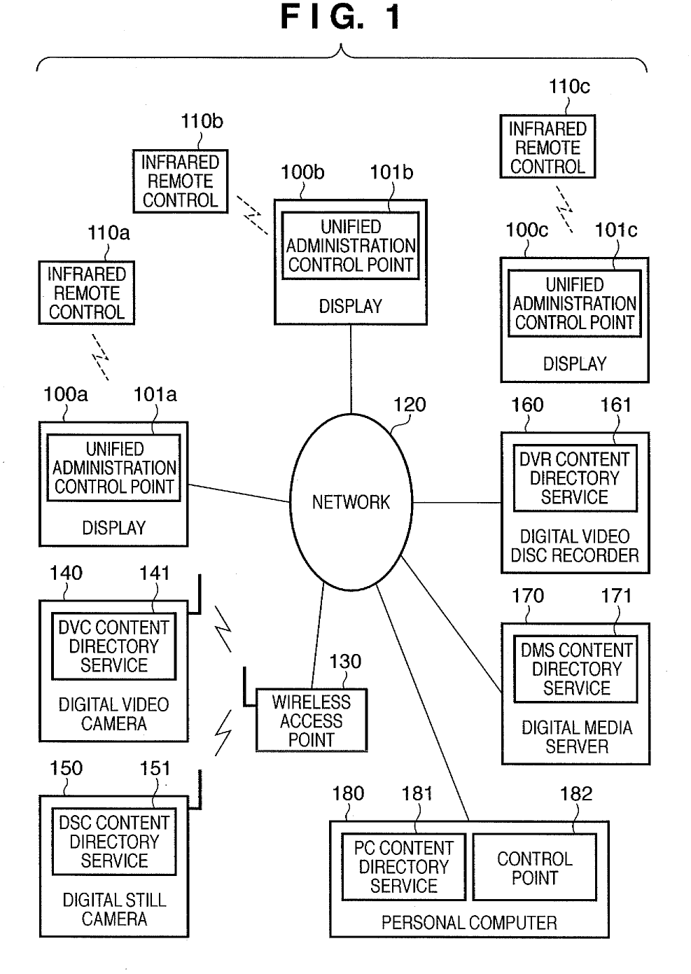

FIG. 1 depicts an example of a system that is configured of a DLNA-compliant device (DLNA system) according to an embodiment. Whereas DLNA is employed according to the embodiment in order to ensure mutual interconnectivity, it would be permissible to employ a specification other than DLNA, provided that it is possible to ensure mutual interconnectivity thereby.

As depicted in FIG. 1, the system according to the first embodiment incorporates a display 100a, 100b, and 100c, and an infrared remote control 110a, 110b, and 110c. The DLNA system according to the embodiment incorporates a digital video camera 140, a digital still camera 150, a digital video disc recorder 160, a digital media server 170, and a personal computer 180. The DLNA system according to the embodiment comprises a network 120 and a wireless (Wi-Fi) access point 130. It is not necessary to incorporate both a wired and a wireless network according to the embodiment; one or the other will be sufficient.

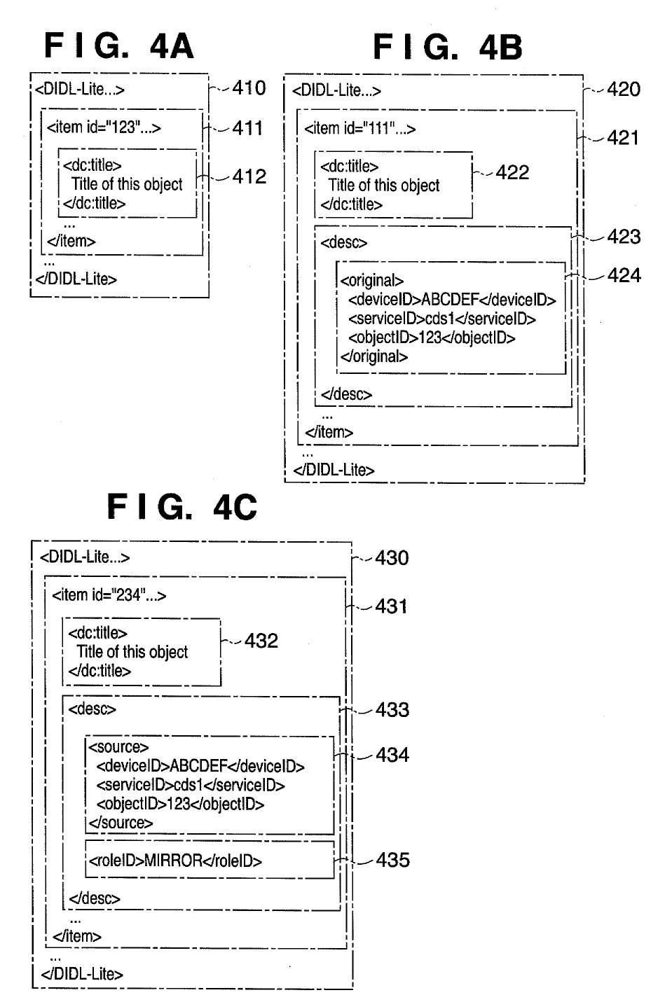

The display 100a, 100b, and 100c are capable of viewing, via a unified administration control point 101a, 101b, and 101c, a content that is within each respective device that is connected via the network 120. The display 100a, 100b, and 100c are controlled by the infrared remote control 110a, 110b, and 110c. It would be permissible for the display 100a, 100b, and 100c to comprise a function for viewing and listening to a television broadcast. The unified administration control point 101a, 101b, and 101c comprise a DLNA-compliant interface, and provide a function that acquires a content list from a content directory service that is within each respective device, as well as a function that edits the content list. Whereas the edit function primarily refers to editing a metadata of an object within, i.e., the content of, the content list, a circumstance is conceivable wherein an actual data of the content may itself be changed at the same time as the metadata thereof. An example of such a circumstance might include such as changing only a title information 412 that is depicted in FIG. 4A described later, or deleting the actual data and the metadata of the content in the course of deleting the content.

The digital video camera 140 is a device for photographing and recording a video image, and comprises a wireless Local Area Network (LAN), i.e., Wi-Fi, function (not shown) and a DVC content directory service 141. Using the Wi-Fi wireless LAN function, the digital video camera 140 is capable of connecting, via the Wi-Fi access point 130, to the network 120. Whereas such recording media as a Mini DV tape, a DVD, a hard disk drive, or an SD memory card are envisioned for recording the video image, the present invention is not restricted thereto. The DVC content directory service 141, comprising a DLNA-compliant interface, provides, for each respective control point, a content list of the content that is within the digital video camera 140, as well as the editing function thereof.

The digital still camera 150 is a device for capturing and recording a photograph, and comprises a wireless Local Area Network (LAN), i.e., Wi-Fi, function (not shown) and a DSC content directory service 151. Using the Wi-Fi wireless LAN function, the digital still camera 150 is capable of connecting, via the Wi-Fi access point 130, to the network 120. Whereas such recording media as a hard disk drive or an SD memory card are envisioned for recording the photograph, the present invention is not restricted thereto. The DSC content directory service 151, comprising a DLNA-compliant interface, provides, for each respective control point, a content list of the content that is within the digital still camera 150, as well as the editing function thereof.

The digital video disc recorder 160 is a device for capturing and recording a photograph, and comprises a network connection function (not shown) and a DVR content directory service 161. Whereas such recording media as a hard disk drive or a DVD are envisioned for recording a television broadcast, the present invention is not restricted thereto. The DVR content directory service 161, comprising a DLNA-compliant interface, provides, for each respective control point, a content list of the content that is within the digital video disc recorder 160, as well as the editing function thereof.

The digital media server 170 is a device for recording a DLNA-compliant content, and comprises a network connection function (not shown) and a DMS content directory service 171. Whereas a hard disk drive is envisioned as the recording medium for recording the content, the present invention is not restricted thereto. The DMS content directory service 171, comprising a DLNA-compliant interface, provides, for each respective control point, a content list of the content that is within the digital media server 170, as well as the editing function thereof.

The personal computer 180 comprises a PC content directory service 181 and a control point 182, in addition to a typical personal computer function. The PC content directory service 181, comprising a DLNA-compliant interface, provides, for each respective control point, a content list of the content that is within the personal computer 180, as well as the editing function thereof. The control point 182, comprising a DLNA-compliant interface, acquires the content list from the content directory service that is within each respective device, and performs an edit thereupon. Whereas it is presumed that the control point 182 is a typical control point, it would be permissible for a unified administration control point, to be described hereinafter, to be installed instead.

FIG. 1 depicts an example of a system configuration, and it would be permissible for any manner of a device to be added thereto that comprises a content directory service. It would also be permissible for a device other than the display 100a, 100b, and 100c to comprise the unified administration control point 101a, 101b, and 101c.

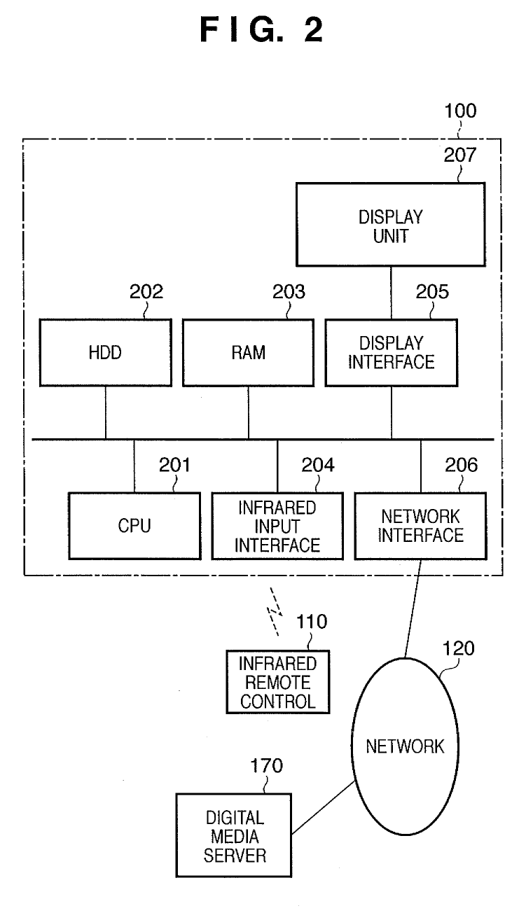

FIG. 2 is a block diagram depicting a hardware configuration example of the display 100a-100c according to the embodiment. Hereinafter, the display 100a-100c will be collectively disclosed as a display 100, and the infrared remote control 110a-110c will be collectively disclosed as an infrared remote control 110. The unified administration control point 101a-101c will be collectively disclosed as a unified administration control point 101 hereinafter.

As depicted in FIG. 2, the display 100 comprises a CPU 201, a RAM 203, a hard disk drive 202, an infrared input interface 204, a display interface 205, a network interface 206, and a display unit 207.

The infrared input interface 204 receives an infrared signal from the infrared remote control 110, and converts the infrared signal thus received into an information that can be processed by a corresponding device driver. The display interface 205 converts a screen information that is received from the corresponding device driver into a signal that can be processed by the display unit 207. The network interface 206 interchangeably converts a signal that is received from the network 120 and the information that is received from the corresponding device driver into one another. Not shown in the illustration is that, in the present circumstance, a program such as an operating system, each respective processing program according to the embodiment, and the device driver is stored on the hard disk drive 202, and is temporarily stored in the RAM 203 and executed as appropriate by the CPU 201.

With regard to the disclosure according to the embodiment and according to another embodiment to be described hereinafter, a configuration whereupon is assigned a common reference numeral across a plurality of illustrations functions in a common manner thereby, and a repetition of a description thereof will be omitted, except where specifically noted to the contrary.

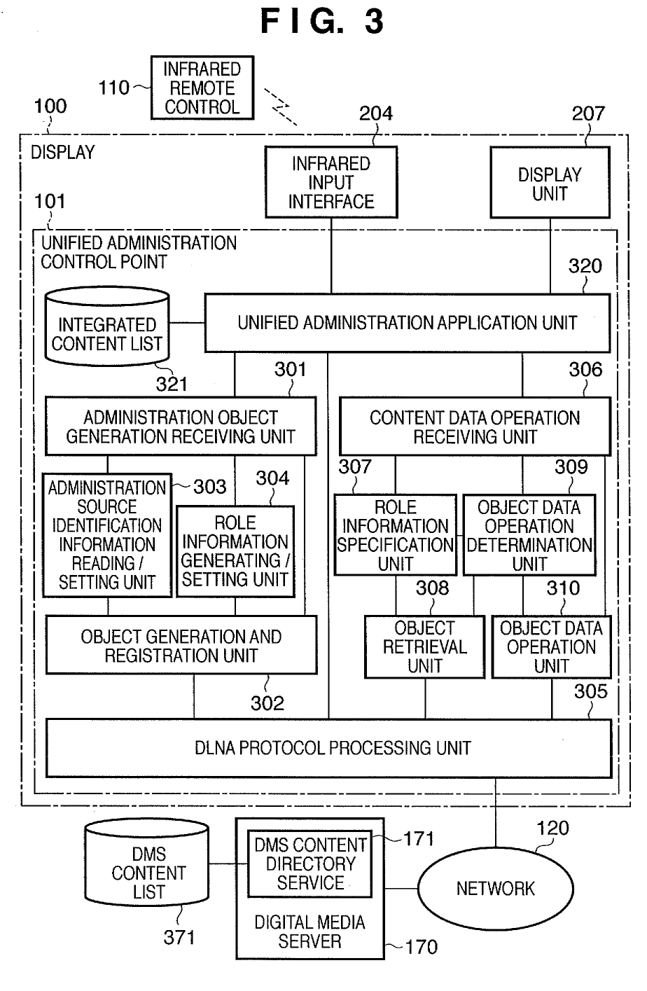

FIG. 3 is a block diagram describing a function configuration of the unified administration control point 101 according to the first embodiment.

As depicted in FIG. 3, the unified administration control point 101 comprises an integrated content list 321, a unified administration application unit 320, an administration object generation receiving unit 301, a DLNA protocol processing unit 305, and a content data operation receiving unit 306. The unified administration control point 101 further comprises an administration source identification information reading/setting unit 303, a role information generating/setting unit 304, and an object generation and registration unit 302. The unified administration control point 101 further comprises a role information specification unit 307, an object retrieval unit 308, an object data operation determination unit 309, and an object data operation unit 310.

The digital media server 170 comprises a DMS content list 371.

The integrated content list 321 assigns an identification information to the content list, either whole or in part, that is contained within each respective content directory service that is connected to the network 120, in order to access each respective object that is contained within the content list. For example, an information is assigned to the DMS content list 371, either whole or in part, that is read out from the DMS content directory service 171, in order to identify the digital media server 170 and the DMS content directory service 171 that provide the object. It is thus possible to generate such as a playlist on the display 100 that gathers a favorite content from each respective device.

The unified administration application unit 320 builds a user interface for performing such as a generation of the playlist, a mirroring of the content, and a backup thereof, and performs a command of a process to each respective unit as appropriate, in response to a request from the user. The unified administration application unit 320 also updates the integrated content list 321 according to a response from each respective unit.

The administration object generation receiving unit 301 receives an administration object generation command from the unified administration application unit 320, and commands each associated unit for the generation of the administration object, the setting of each respective type of administration information, and the registration of the administration object. The administration source identification information reading/setting unit 303 accepts the command from the administration object generation receiving unit 301, reads out the identification information of the administration source object from either the integrated content list 321 or the user request, and sets a metadata of the administration object. The role information generating/setting unit 304 accepts the command from the administration object generation receiving unit 301, generates the role information in accordance with the inputted user request, and sets the metadata of the administration object. The object generation and registration unit 302 accepts the command from the administration object generation receiving unit 301, generates the metadata of the administration object, and registers the metadata with the content directory service, in accordance with the user request.

The content data operation receiving unit 306 accepts the command from the unified administration application unit 320, and commands the retrieval of the object to be operated upon, the determination of a description of an operation, and an execution of the operation. The role information specification unit 307 specifies an associated role information to the object retrieval unit 308, to be described hereinafter, in response to the description of the content data operation that is received from the content data operation receiving unit 306. The object retrieval unit 308 performs a retrieval of the object that is within each respective content directory service, in accordance with the specification of the role information that is received from the role information specification unit 307 and the identification information of the administration source object. The object data operation determination unit 309 determines the operation for the retrieval result, i.e., the object, that is received from the object retrieval unit 308, in accordance with the role information that is received from the role information specification unit 307 and the description of the content data operation that is received from the content data operation receiving unit 306. The object data operation unit 310 executes the object data operation via the DLNA protocol processing unit 305, to be described hereinafter, in accordance with the determination of the object data operation determination unit 309.

The DLNA protocol processing unit 305 performs a transmission and a reception of a data, via the network 120, in accordance with each respective type of protocol that complies with DLNA.

FIGS. 4A-4C depict an example of a metadata of an object according to the first embodiment. As depicted in FIGS. 4A-4C, the metadata of the object is configured of a content list 410 and 430 that is within each respective device, and an integrated content list 420. The content lists are defined in Extensible Markup Language (XML), for example.

The content list 410 is a list of the content, i.e., the object, that is stored in either the digital media server 170, or the digital video camera 140, the digital still camera 150, or the digital video disc recorder 160. The content list 410 is stored in either the digital media server 170, or the digital video camera 140, the digital still camera 150, or the digital video disc recorder 160.

The content list 410 denotes an example wherein a content list DIDL-Lite possesses an administration source object <item> 411. The administration source object 411 possesses a title information <dc:title>, for example.

The integrated content list 420 is a list of a reference object that denotes a reference to the content, i.e., the object, which is stored in either the digital media server 170, or the digital video camera 140, the digital still camera 150, or the digital video disc recorder 160. The integrated content list 420 is stored in the display 100.

The integrated content list 420 depicts an example wherein the content list DIDL-Lite possesses a reference object <item> 421, which denotes a reference of the administration source object 411. The reference object 421 possesses a title information <dc:title> 422, and a user-defined metadata <desc> 423. The user-defined metadata 423 possesses an object identification information <original> 424, for identifying the administration source object 411. The object identification information 424 incorporates a device identification information <deviceID> that identifies a device, a service identification information <serviceID> that identifies a service that is within the device, and an object identification information <objectID> that identifies an object that is within the service.

The content list 430 is a list of a mirroring object, a backup object, and a joining object for mirroring, backing up, or joining a content, i.e., an administration source object, which is stored in either the digital media server 170, or the digital video camera 140, the digital still camera 150, or the digital video disc recorder 160. The mirroring object, the backup object, and the joining object will hereinafter be collectively referred to as the administration object. The mirroring object is an object that is taken in synchronization with the administration source object, and the mirroring object is updated when the administration source object is updated. The backup object is an object that maintains a content of the administration source object of a specified date, and does not change even if the administration source object is updated. The joining object is an object that configures a single content by being joined with the administration source object, and is used in such a circumstance as recording a video of an extended duration. The content list 430 is stored in either the digital media server 170, or the digital video camera 140, the digital still camera 150, or the digital video disc recorder 160, for example.

The content list 430 depicts an example wherein the content list DIDL-Lite possesses an administration object <item> 431 that denotes a mirroring of the administration source object 411. The administration object 431 comprises a title information dc:title> 432 and a user-defined metadata <desc> 433. The user-defined metadata 433 comprises an object identification information <source> 434 and an administration object role information <roleID> 435, for identifying the administration source object 411. The object identification information 434 incorporates a device identification information <deviceID> that identifies a device, a service identification information <serviceID> that identifies a service that is within the device, and an object identification information <objectID> that identifies an object that is within the service. A text string “MIRROR,” which denotes a mirrored data, is set in the administration object role information <roleID> 435. At a minimum, the roles of mirroring, backing up, and joining are present, and have the role information of “MIRROR,” “BACKUP,” and JOIN, respectively. It would be permissible for the role information <roleID> 435 to be set to a plurality of roles, for example, “MIRROR” and “JOIN.” Thus, the role information that is within the object is set.

The administration object whereof the role information is “MIRROR” is the mirror object. The administration object whereof the role information is “BACKUP” is the backup object. The administration object whereof the role information is “JOIN” is the join object.

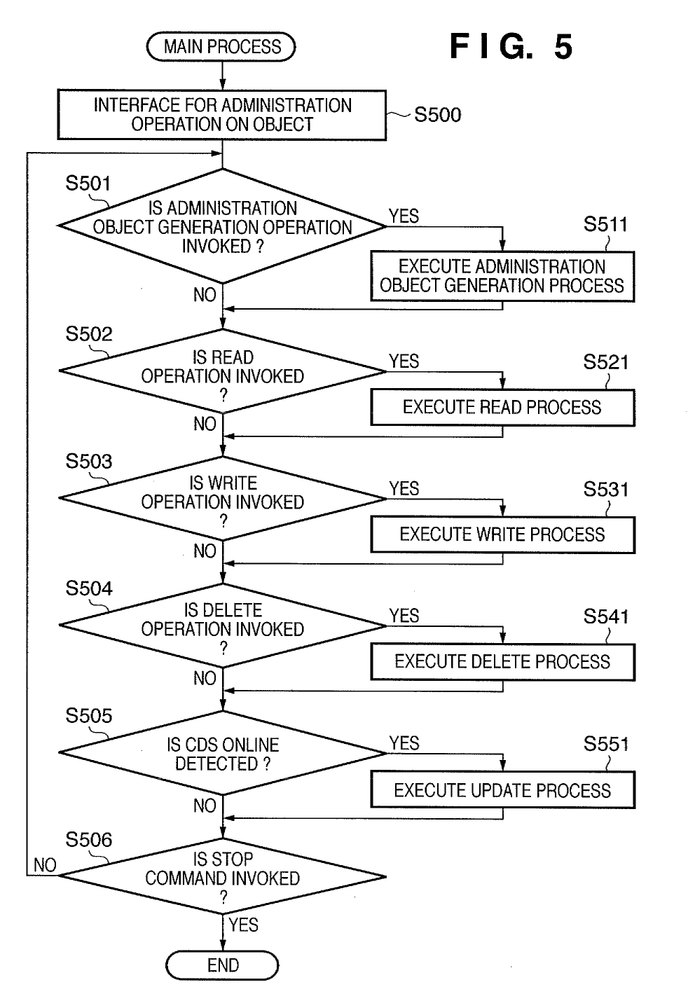

FIG. 5 is a flowchart depicting a main process of the unified administration control point 101 according to the embodiment. The process that is described hereinafter in the flowchart in FIG. 5-FIG. 10 is implemented by the CPU 201 of the display 100 executing a predetermined control program.

When the main process commences, in step S500, the unified administration control point 101 presents a user interface for an administration operation on the object to the display unit 207. The user interface displays an interface screen on the display unit 207, and capable of accepting an input, by way of an operation of the infrared remote control 110, of a specification of an object to be operated upon and a command of an administration operation for the object. The administration operation that is available to be commanded via the user interface includes such as a generation, a read, a write, an update, or a delete of the administration object.

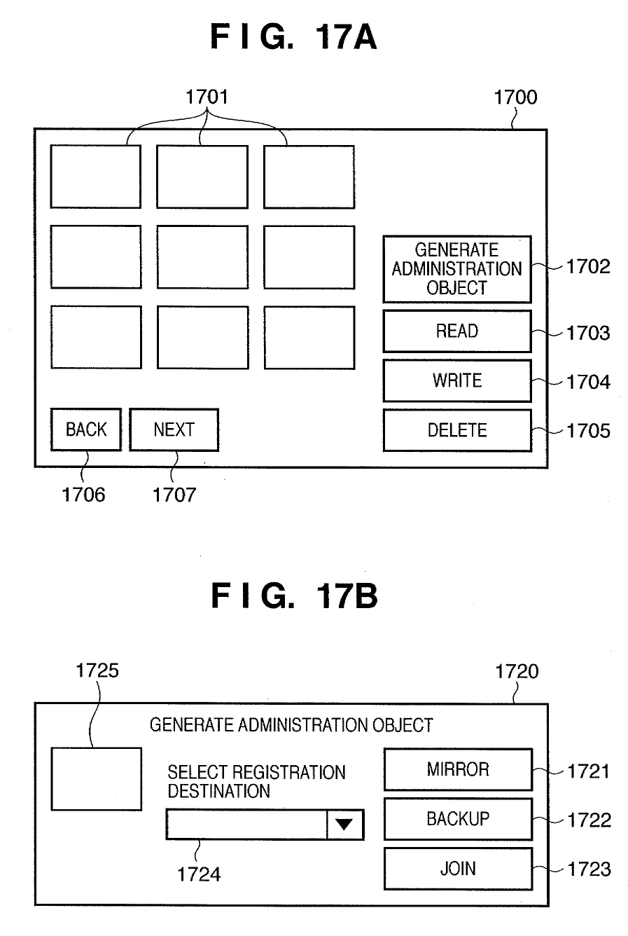

FIG. 17A depicts an example of an administration operation user interface screen according to the embodiment. An interface screen 1700 that is depicted in FIG. 17A is presented to the display unit 207, and it is possible to select an object icon 1701 and an administration operation 1702-1705, by way of the operation of the infrared remote control 110. The object icon 1701 is an icon that represents, for example, an object that is registered in the DMS content list 371, and the administration source object 411 that is contained within the content list 410. Selecting the icon that is displayed on the interface screen 1700 allows the user to select the object that is to be operated upon. If the object icon cannot be displayed on a single screen, it is possible to navigate between a display page of the object icon, or scroll the display unit of the object icon, by operating a back button 1706 and a next button 1707.

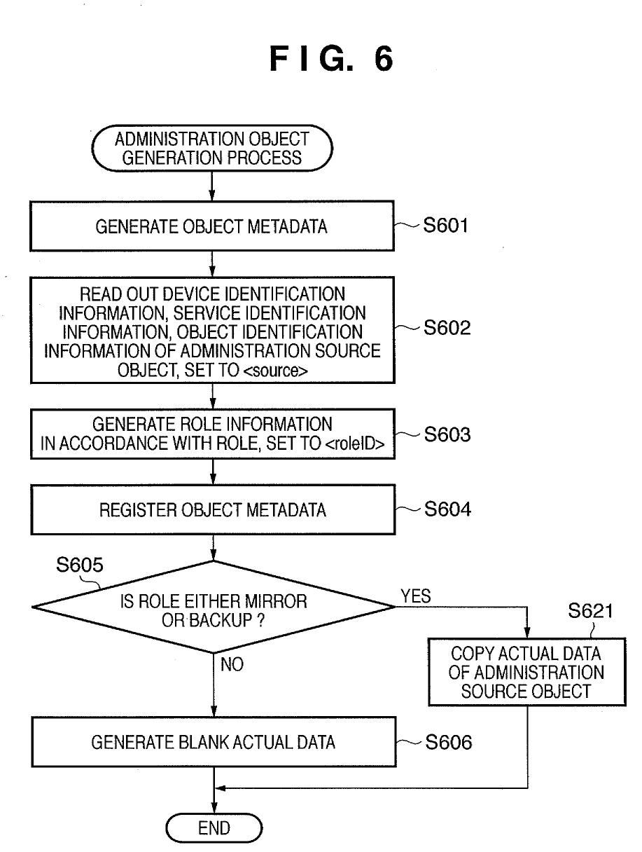

In step S501, the unified administration application unit 320 verifies whether or not the administration object generation operation from the interface screen 1700 is invoked. If the administration object generation operation is invoked, i.e., if, for example, the object icon 1701 is selected, and the administration object generation 1702 specified, in the interface screen 1700, the process proceeds from step S501 to step S511. In step S511, the unified administration application unit 320, executes an administration object generation process to be described hereinafter with reference to FIG. 6, and advances the process to step S502. If it is determined in step S501 that the administration object generation operation is not invoked, the process proceeds to step S502.

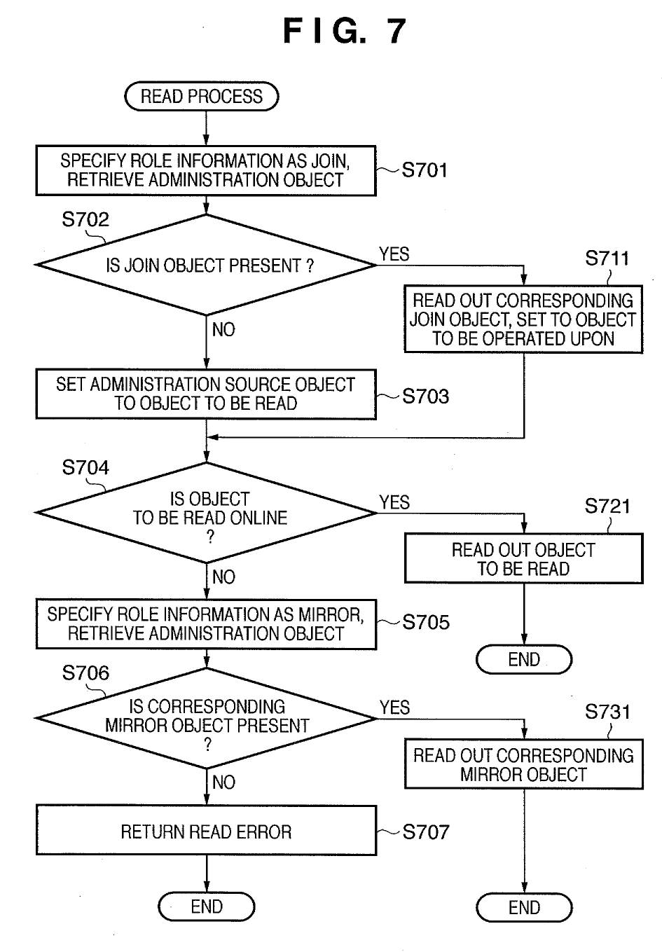

In step S502, the unified administration application unit 320 verifies whether or not an object data read operation, i.e., the selection of the object icon 1701 and the specification of a read 1703, in the interface screen 1700 is invoked. If it is determined in step S502 that the read operation is invoked, the process proceeds to step S521. In step S521, the unified administration application unit 320 executes a read process to be described hereinafter with reference to FIG. 7, and advances the process to step S503. If it is determined in step S502 that the read operation is not invoked, the process proceeds to step S503.

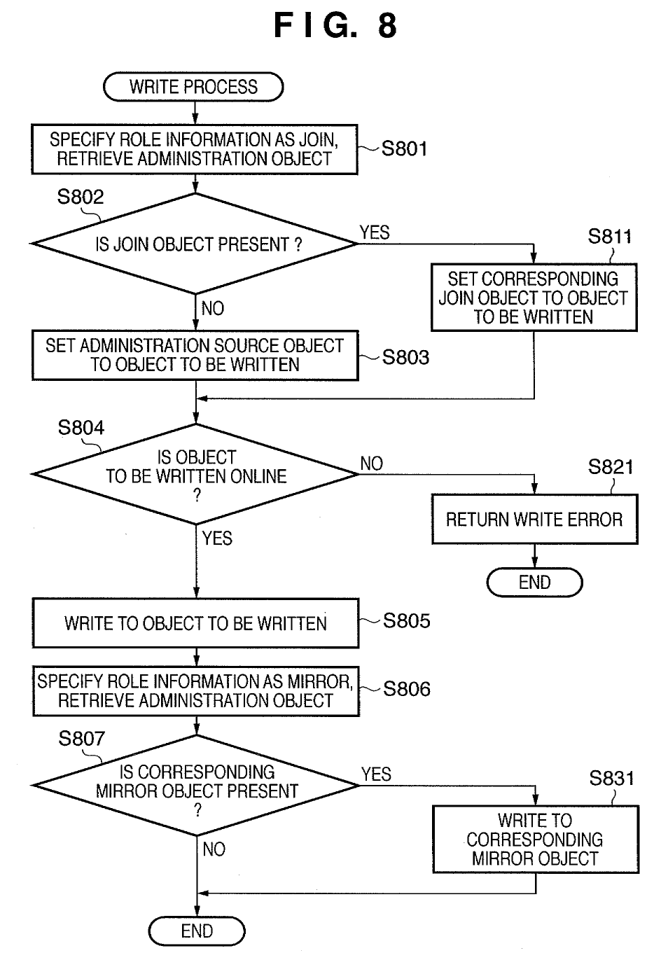

In step S503, the unified administration application unit 320 verifies whether or not an object data write operation, i.e., the selection of the object icon 1701 and the specification of a write 1704, in the interface screen 1700 is invoked. If the write operation is invoked, the process proceeds from step S503 to step S531. In step S531, the unified administration application unit 320 executes a write process to be described hereinafter with reference to FIG. 8, and advances the process to step S504. If it is determined in step S503 that the write operation is not invoked, the process proceeds to step S504.

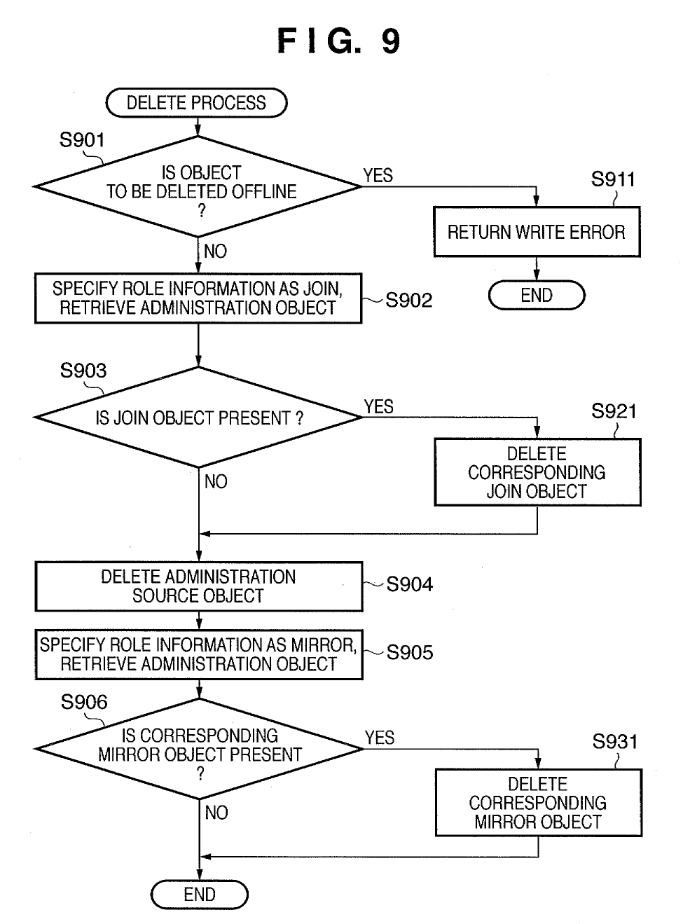

In step S504, the unified administration application unit 320 verifies whether or not an object data delete operation, i.e., the selection of the object icon 1701 and the specification of a delete 1705, in the interface screen 1700 is invoked. If it is determined in step S504 that the delete operation is invoked, the process proceeds to step S541. In step S541, the unified administration application unit 320 executes a delete process to be described hereinafter with reference to FIG. 9, and advances the process to step S505. If it is determined in step S504 that the delete operation is not invoked, the process proceeds to step S505.

In step S505, the unified administration application unit 320 verifies whether or not a content directory service (CDS) online detection is invoked. According to the embodiment, the unified administration application unit 320 discovers a device, comprising DLNA (or UPnP, to be exact) on a network, through a process called “discovery,” and uses a mechanism that identifies the service that the device provides to verify whether or not the CDS online detection is invoked. If the CDS, for example, the DSC content directory service 151 of the digital still camera 150, is detected as being online, the process proceeds to step S551. In step S551, the unified administration application unit 320 executes an update process to be described hereinafter with reference to FIG. 6, and advances the process to step S506. If it is determined in step S505 that no online detection is made, the process proceeds to step S506.

In step S506, the unified administration application unit 320 verifies whether or not a stop command is received from the user interface. If it is determined that the stop command is not received, the process returns to step S501. If it is determined in step S506 that the stop command is received, the process terminates.

FIG. 6 is a flowchart depicting the administration object generation process according to the first embodiment. The administration object generation process depicted in step S511 is executed herein.

In step S601, the administration object generation receiving unit 301 commands the object generation and registration unit 302 to generate the object metadata. According to the embodiment, the administration object generation receiving unit 301 commands the generation of the object metadata in response to the specification of the object icon 1701 and the administration object generation 1702, in the interface screen 1700. In the present circumstance, the intended object, i.e., the administration source object 411, is the object that is denoted by the object icon 1701 thus selected. The object metadata corresponds to the administration object 431. In step S602, the administration source identification information reading/setting unit 303 reads out, and sets to a source of the object metadata, i.e., the object identification information 434, the device identification information <deviceID>, the service identification information <serviceID>, and the object identification information <objectID> of the administration source object. In the present circumstance, the device identification information is the identification information of the digital media server 170 that comprises the administration source object 411. The object identification information 434, which allows a unique identification of the administration source object with regard to the system, is thus set. The administration source object is the object that corresponds to the object icon 1701 that is specified in the interface screen 1700.

In step S603, the role information generating/setting unit 304 generates the role information, in accordance with the role that is specified via the user interface, and sets the roleID of the object metadata thereto. For example, an interface screen 1720 shown in FIG. 17B is displayed in response to the specification of the administration object generation 1702 in the interface screen 1700. A selected object icon 1725 is displayed in the interface screen 1720 as depicted in FIG. 17B, and it is possible to specify a role of the administration object that is to be generated for the administration source object via a button 1721, 1722, and 1723. The mirror button 1721, the backup button 1722, and the join button 1723 are employed to set the specified role information in the roleID. The role information 435, which allows a unique identification of a role that is to be carried out by the administration object, is thus set. In step S604, the object generation and registration unit 302 registers the administration object metadata.

A destination of the registration of the administration object is specified by selecting a desired device from a device list that is depicted in a registration destination selection pull-down menu 1724. For example, if the destination of the registration of the administration object is the digital media server 170, the object metadata is registered in the DMS content list 371.

Also, it is possible to register the object metadata in a content list of the same device, such as an integrated content list. In such a circumstance, it is necessary for the integrated content list 321 to be connected to the object generation and registration unit 302, the object retrieval unit 308, and the object data operation unit 310, with regard to the connection relationship that is depicted in FIG. 3. It is thus necessary to treat the integrated content list 321 as having an equal status with the DLNA protocol processing unit 305.

In step S605, the object generation and registration unit 302 verifies whether or not the role is either of the “MIRROR” or the “BACKUP.” If the role is either of the “MIRROR” or the “BACKUP,” the process proceeds to step S621, whereas if the role is neither of the “MIRROR or the BACKUP,” the process proceeds to step S606. In step S621, the object generation and registration unit 302 copies an actual data of the administration source object, and terminates the process. In step S606, the object generation and registration unit 302 generates a blank actual data, and terminates the process. The actual data of the joining object is thus a blank data.

A save location of either the actual data or the blank data is a storage medium of the device that is specified as the destination of the registration of the administration object in the registration destination selection pull-down menu 1724. For example, if the digital media server 170 is specified as the destination of the registration, the save location thereof is a storage medium (not shown) that the digital media server 170 comprises. In such a circumstance, the actual data is copied from a storage medium of a digital media server that is a copy source to a storage medium of a digital media server that is a copy destination. If a destination of a registration is specified so as to generate the administration object within the content list of the same device, i.e., the integrated content list, either the actual data or the blank data is saved to the hard disk drive 202, for example.

FIG. 7 is a flowchart depicting a read process according to the embodiment. The read process depicted in step S521 is executed herein.

In step S701, the “JOIN” is specified by the role information specification unit 307, and the identification information of the administration source object to be operated upon is specified by the content data operation receiving unit 306. The object retrieval unit 308 retrieves the administration object in accordance with the above specifications. The identification information of the administration object to be operated upon is the identification information of the administration source object that is selected in step S502, and is the administration source object, the role information whereof is “JOIN.” In step S702, the object data operation determination unit 309 verifies whether or not the administration source object that is selected in step S502 and the role information whereof is “JOIN” (hereinafter “the JOIN object”) is present, based on a result of the retrieval thereof. The JOIN object of the administration source object thus selected is retrieved. If the JOIN object is present, the process proceeds from step S702 to step S711. In step S711, the object data operation determination unit 309 reads the corresponding JOIN object and the administration source object that is specified in step S502, and determines the object to be operated upon. If, on the other hand, it is determined in step S702 that the JOIN object is not present, the process proceeds to step S703. In step S703, the object data operation determination unit 309 reads the administration source object that is specified in step S502, and determines the object to be operated upon.

Unless otherwise specified hereinafter, it is presumed that the specification of the role information is performed by the role information specification unit 307, the identification information of the administration object is specified by the content data operation receiving unit 306, and the determination of the operation is performed by the object data operation determination unit 309.

In step S704, the object data operation unit 310 determines whether or not the object to be read is online, i.e., the object data operation unit 310 determines whether or not the object to be read is present on the network, and if the object to be read is determined to be online, the process proceeds to step S721. In step S721, the object data operation unit 310 reads the object to be read, and terminates the process. If, on the other hand, the object to be read is not online, the process proceeds to step S705.

In step S705, the role information specification unit 307 specifies the role information to be “MIRROR.” The object retrieval unit 308 retrieves the administration source object identification information that is specified by the object data operation determination unit 309, and the administration object that comprises the specified MIRROR role information. The object retrieval unit 308 retrieves a MIRROR object of the selected administration source object from within the network 120. The administration source object with the specified role information of “MIRROR” will hereinafter be referred to as a MIRROR object. If the MIRROR object that corresponds to a retrieval condition of step S705 is present, the process proceeds from step S706 to step S731. In step S731, the object data operation unit 310 reads the MIRROR object that is retrieved in step S705, and terminates the process. If, on the other hand, it is determined that the corresponding MIRROR object is not present in step S706, in step S707 the object data operation determination unit 309 returns a read error to the content data operation receiving unit 306, and terminates the process. The read of the backup object is thus not performed.

FIG. 8 is a flowchart depicting a write process according to the embodiment. The write process depicted in step S531 is executed herein.

In step S801, the “JOIN” is specified by the role information specification unit 307, and the identification information of the administration source object to be operated upon is specified by the content data operation receiving unit 306. The identification information of the administration object to be operated upon is the identification information of the administration source object that is selected in step S503. The object retrieval unit 308 retrieves the JOIN object of the administration object, i.e., the administration object whereof the role information is JOIN, in accordance with the respective specifications thereof. The object retrieval unit 308 retrieves a JOIN object of the selected administration source object. In step S802, the object data operation determination unit 309 verifies whether or not the JOIN object is present, based on the result of the retrieval thereof. If the JOIN object is present, the process proceeds from step S802 to step S811. In step S811, the object data operation determination unit 309 determines the corresponding JOIN object and the administration source object that is specified in step S503 to be an object to be written. If on the other hand, the JOIN object is not present, the process proceeds to step S803. In step S803, the object data operation determination unit 309 determines the administration source object that is specified in step S503 to be the object to be written.

In step S804, the object data operation unit 310 determines whether or not the object to be written is online. If the object to be written is not online, the process proceeds to step S821. In step S821, the object data operation determination unit 309 returns a write error to the content data operation receiving unit 306, and terminates the process. If, on the other hand, the object to be read is online, the process proceeds to step S805. In step S805, the object data operation unit 310 executes a write on the object to be written.

In step S806, the role information specification unit 307 specifies the role information to “MIRROR.” The object retrieval unit 308 retrieves the administration source object identification information that is specified by the object data operation determination unit 309, and the administration object that comprises the specified “MIRROR” role information, from within the network 120. The object retrieval unit 308 retrieves the MIRROR object of the selected administration source object. If it is determined that the corresponding MIRROR object is not present in step S807, the process is terminated. If, on the other hand, it is determined that the corresponding MIRROR object is present in step S807, the process proceeds to step S831. In step S831, the object data operation unit 310 writes the same data to the MIRROR object that is retrieved in step S806 as to the selected administration object, and terminates the process. The write to the backup object is thus not performed.

FIG. 9 is a flowchart depicting a delete process according to the embodiment. The delete process depicted in step S541 is executed herein.

In step S901, upon receipt of the delete command from the content data operation receiving unit 306, the object data operation unit 310 verifies whether or not the object to be deleted is offline, i.e., whether or not the object to be deleted is connected to the network 120. If the object to be deleted is determined to be offline in step S901, the process proceeds to step S911. In step S911, the object data operation unit 310 returns a delete error to the content data operation receiving unit 306, and terminates the process.

If the object to be deleted is determined not to be offline in step S901, the process proceeds to step S902. In step S902, the “JOIN” is specified by the role information specification unit 307, and the identification information of the administration source object to be deleted is specified by the content data operation receiving unit 306. The identification information of the administration object to be deleted is the identification information of the administration source object that is selected in step S504. The object retrieval unit 308 retrieves the selected administration object from within the network 120, in accordance with the above specifications. The object retrieval unit 308 retrieves the JOIN object of the selected administration source object.

If the JOIN object is present as a result of the retrieval, the process proceeds from step S903 to step S921. In step S921, the object data operation unit 310 deletes the JOIN object thus retrieved, and the process proceeds to step S904. If, on the other hand, the JOIN object is not present, the process proceeds from step S903 to step S904. In step S904, the object data operation unit 310 deletes the administration source object to be deleted. The object data operation unit 310 deletes the administration source object thus selected.

In step S905, the role information specification unit 307 specifies a role of an object to be retrieved to MIRROR, and the object retrieval unit 308 retrieves the MIRROR object from within the network 120 that corresponds to the administration source object that is selected to be deleted. If the corresponding MIRROR object is present, the process proceeds from step S906 to step S931, wherein the object data operation unit 310 deletes the MIRROR object thus retrieved, and terminates the process. If, on the other hand, the corresponding MIRROR object is not present in step S906, the process terminates. The deletion of the backup object is thus not performed.

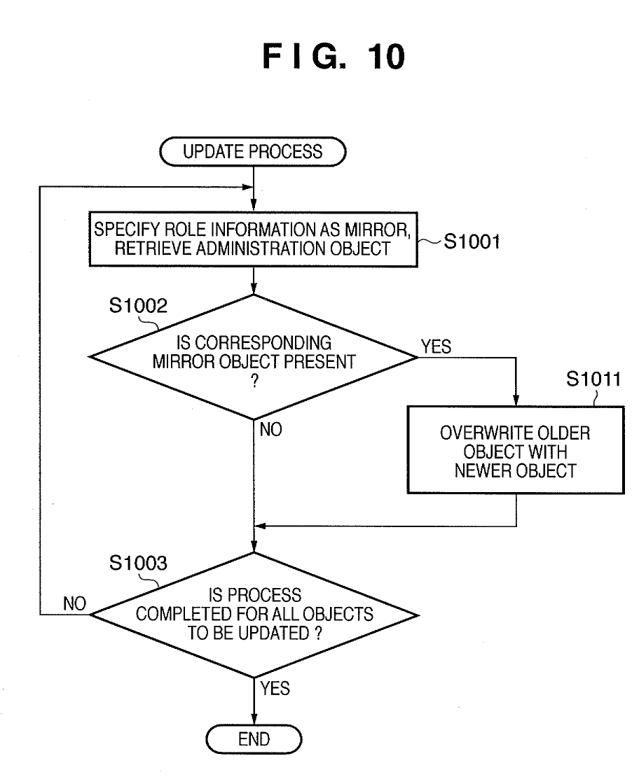

FIG. 10 is a flowchart depicting an update process according to the embodiment. The update process depicted in step S551 is executed herein.

In step S1001, the “MIRROR” is specified by the role information specification unit 307, and the identification information of the administration source object to be updated is specified by the content data operation receiving unit 306. The object retrieval unit 308 retrieves the MIRROR object in accordance with the above specifications. The object to be retrieved in step S1001 is as follows:

1. A MIRROR object that possesses the object identification information 424 of the object that is within the CDS that is detected online, i.e., as being connected to the network 120; and

2. A MIRROR object that is within the CDS that is detected online, i.e., as being connected to the network 120.

In step S1002, if it is determined that the corresponding MIRROR object is present, the process proceeds to step S1011. In step S1011, the object data operation unit 310 overwrites an object with an older date and time with an object with a newer date and time. If, on the other hand, the corresponding MIRROR object is not present in step S1002, the process proceeds to step S1003.

In step S1003, the object data operation determination unit 309 verifies whether or not the process has been completed for all of the objects to be updated. If the process has not been completed for all of the objects to be updated, the process returns to step S1001 in order to execute the process on the next object to be updated. If, on the other hand, it is determined in step S1003 that the process has been completed for all of the objects to be updated, the process terminates. The object to be updated, either the administration source object or the MIRROR object, is thus updated to the latest state. Also, if the administration source object that corresponds to the MIRROR object is not present in step S1011, the MIRROR object is deleted.

According to the first embodiment, the administration object is determined, in step S702 or step S706, for example, that carries out the role to be processed in response to the administration operation thus requested, i.e., read, write, delete, or update, whereupon the corresponding administration object is retrieved and the process carried out. The sequence for carrying out the process on the administration object is not restricted thereto, however. It would be permissible, for example, to retrieve an object that possesses an object identification information that is identical to the administration source object whereupon the administration operation is to be performed, to reference the role information that is incorporated within the object thus retrieved, and determine and execute the process for the administration object. A configuration would be permissible whereby the process is executed that is determined in accordance with a requested operation and the role information that is set in the administration object when the operation is requested for the administration source object.

According to the first embodiment, with regard to the generation of the administration object, an object identification information for identifying the administration source object and a role information that denotes the role that the administration object carries out are set within the administration object. The process that is determined in accordance with the operation that is requested for the administration source object and the role information thus set is carried out on the administration object whereupon the object identification information of the administration source object is set, and in accordance with the operation thus requested. The role information and the identification information is thus set within the administration object, and the process is determined for the administration object in accordance with the operation and the role information for the administration source object. Accordingly, it is possible to perform such a data administration as a mirroring on a per content basis without a discrepancy arising even when each respective device is not powered on and off in synchrony with the other device.

### Second Embodiment

Following is a detailed description of a second embodiment, with reference to the attached drawings. A system configuration, a hardware configuration, and a main process according to the unified administration control point according to the second embodiment is similar to the first embodiment, i.e., FIG. 1, FIG. 2, and FIG. 5. A read process, a write process, a delete process, and an update process according to the second embodiment is similar to the first embodiment, i.e., FIGS. 7-10.

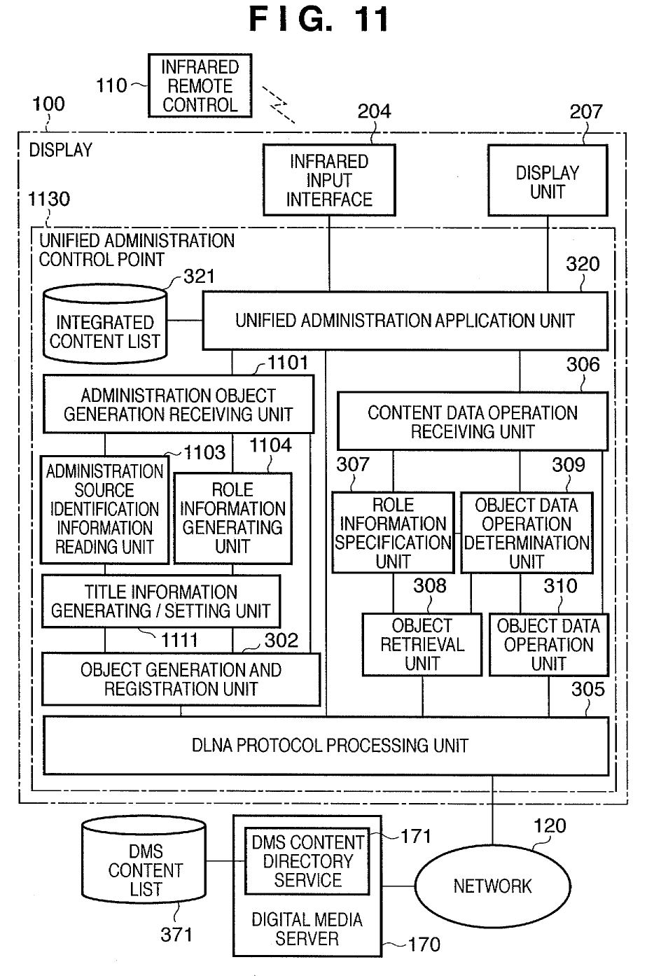

FIG. 11 is a block diagram depicting a function configuration example of a unified administration control point according to the second embodiment. As depicted in FIG. 11, a unified administration control point 1130 comprises an integrated content list 321, a unified administration application unit 320, an administration object generation receiving unit 1101, a DLNA protocol processing unit 305, and a content data operation receiving unit 306. The unified administration control point 1130 further comprises an administration source identification information reading unit 1103, a role information generating unit 1104, a title information generating/setting unit 1111, and an object generation and registration unit 302. The unified administration control point 1130 further comprises a role information specification unit 307, an object retrieval unit 308, an object data operation determination unit 309, and an object data operation unit 310. The digital media server 170 comprises a DMS content list 371.

The administration object generation receiving unit 1101 receives an administration object generation command from the unified administration application unit 320, and commands each associated unit for the generation of the object, the setting of each respective type of administration information, and the registration of the object. The administration source identification information reading unit 1103 accepts the command from the administration object generation receiving unit 1101, reads out the identification information of the administration source object from either the integrated content list or the user request, and notifies the title information generating/setting unit 1111. The role information generating unit 1104 accepts the command from the administration object generation receiving unit 1101, generates the role information in accordance with the user request, and notifies the title information generating/setting unit 1111. The title information generating/setting unit 1111 generates a title information and sets the title information thus generated to a metadata of the object, in accordance with the object identification information that is received from the administration source identification information reading unit 1103 and the role information that is received from the role information generating unit 1104.

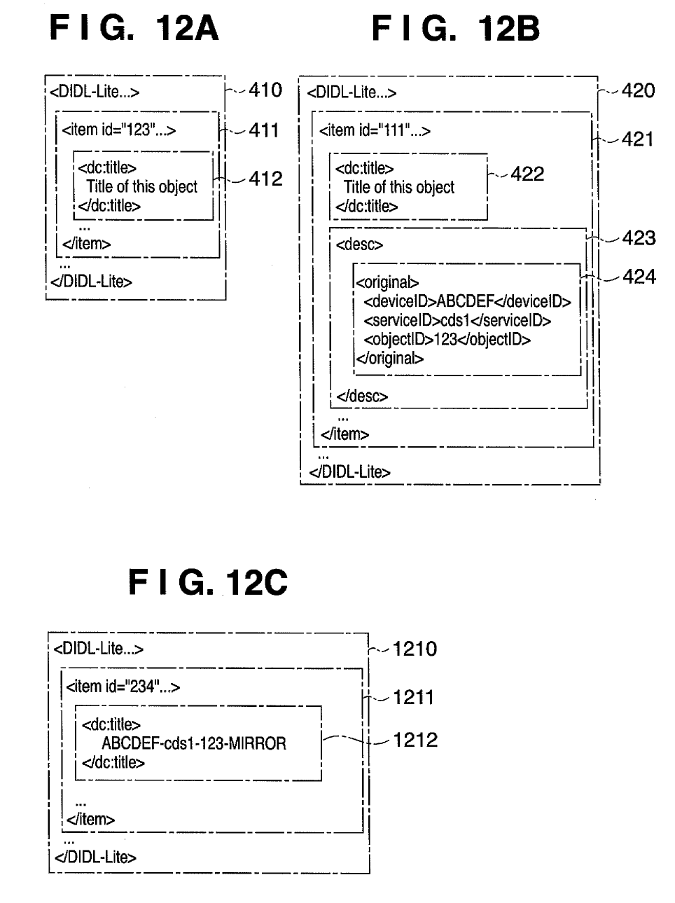

FIGS. 12A-12C depict an example of the metadata of the object according to the second embodiment. As depicted in FIGS. 12A-12C, the metadata of the object is configured of a content list 410 and 1210 that is within each respective device, and an integrated content list 420. The content lists are defined in Extensible Markup Language (XML), for example.

The content list 1210 that incorporates the administration object denotes an example wherein a content list DIDL-Lite possesses an administration object <item> 1211 that denotes a mirroring of the administration source object 411. The administration object 1211 possesses a title information <dc:title> 1212. The title information 1212 is set to a text string that generated from the object identification information that is used to identify the administration source object 411. In FIG. 12C, the text string is “ABCDEF-cds1-123-MIRROR,” which is formed from “ABCDEF,” which identifies the device, “cds1,” which identifies the service that is within the device, “123,” which identifies the object that is within the service, and “MIRROR,” which is the role information of the administration object.

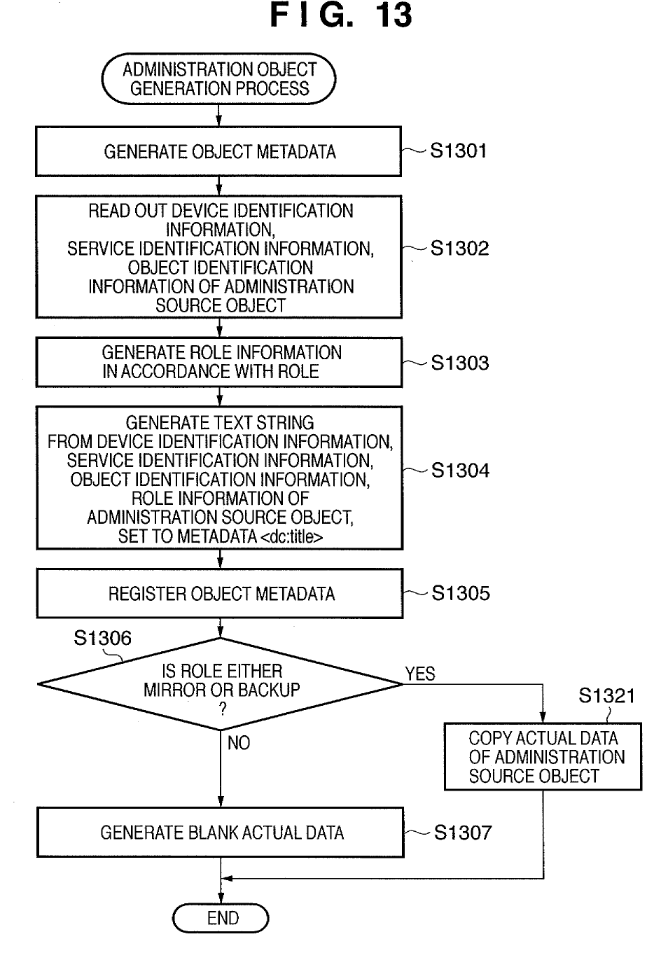

FIG. 13 is a flowchart depicting an administration data generation process, i.e., a process that generates the administration object 1211, according to the second embodiment. The administration object generation process commences with step S511, preceding.

In step S1301, the administration object generation receiving unit 1101 commands the object generation and registration unit 302 to generate the object metadata. In the present circumstance, the object to be operated upon, i.e., the administration source object, is the object that is denoted by the object icon 1701 thus selected. The object metadata corresponds to the administration object 1211. In step S1302, the administration source identification information reading unit 1103 reads a device identification information, a service identification information, and an object identification information of the administration source object thus selected. In step S1303, the role information generating unit 1104 generates the role information in accordance with the role that is user-specified via the user interface that is provided by the unified administration control point 1130.

In step S1304, the title information generating/setting unit 1111 generates the text string from the device identification information, the service identification information, and the object identification information of the administration source object, and the role information, and the title information generating/setting unit 1111 sets the text string thus generated to the <dc:title> of the object metadata. The identification information and the role information thus referenced is the identification information and the role information that is either acquired or generated in step S1302 and step S1303. In step S1305, the object generation and registration unit 302 registers the object metadata.

In step S1306, the object generation and registration unit 302 verifies whether or not the role that is set for the administration object is either of a mirroring or a backup. If the role thus set is either of a mirroring or a backup, the process proceeds to step S1321. In step S1321, the object generation and registration unit 302 copies an actual data of the administration source object. If the role thus set is neither a mirroring nor a backup, the process proceeds from step S1306 to step S1307. In step S1307, the object generation and registration unit 302 generates a blank actual data, and terminates the process.

With regard to the preceding configuration, the text string that incorporates the object identification information and the role information of the administration source object is set to the title value <dc:title> that is within the administration object. The administration object that comprises the title value that incorporates the object identification information of the administration source object is acquired in the process that corresponds to each respective administration operation that is depicted in FIGS. 7-10. The process for the administration object that is thus acquired is determined in accordance with the role information, i.e., MIRROR, BACKUP, or JOIN, that is incorporated within the title value.

According to the second embodiment, the object identification information and the role information of the administration source object is set in the title information that is a prerequisite under DLNA. It is thus possible to generate the administration object even within a content directory service that does not comply with the user-defined metadata.

### Third Embodiment

Following is a detailed description of a third embodiment, with reference to the attached drawings. A system configuration, a hardware configuration, and a main process according to the unified administration control point according to the third embodiment is similar to the first embodiment, i.e., FIG. 1, FIG. 2, and FIG. 5. A read process, a write process, a delete process, and an update process according to the third embodiment is similar to the first embodiment, i.e., FIGS. 7-10.

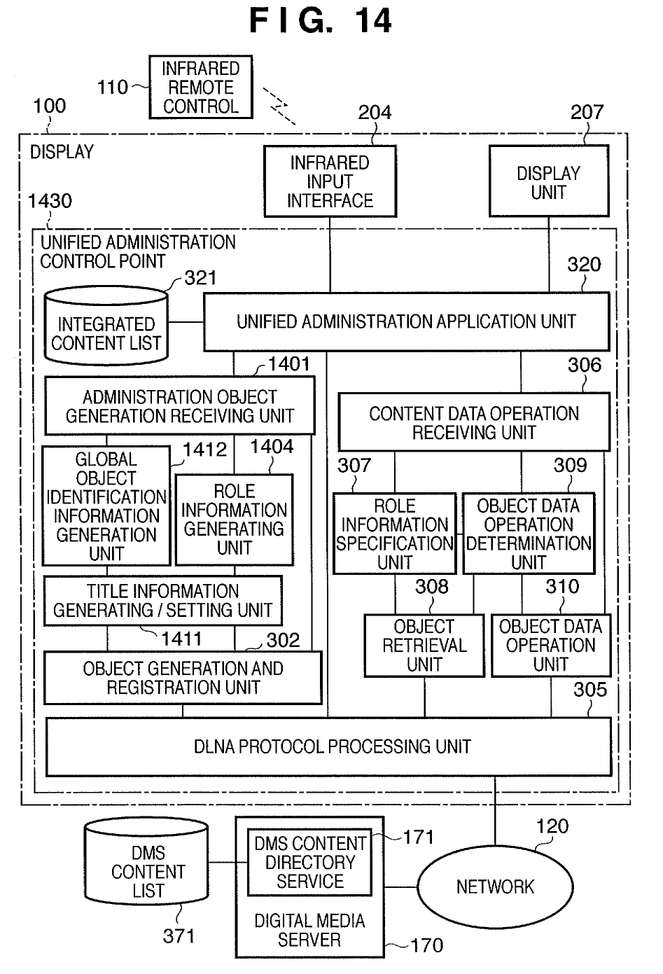

FIG. 14 is a block diagram describing a function configuration example of a unified administration control point according to the third embodiment. As depicted in FIG. 14, a unified administration control point 1430 comprises an integrated content list 321, a unified administration application unit 320, an administration object generation receiving unit 1401, a DLNA protocol processing unit 305, and a content data operation receiving unit 306. The unified administration control point 1430 further comprises a global object identification information generation unit 1412, a role information generating unit 1404, a title information generating/setting unit 1411, and an object generation and registration unit 302. The unified administration control point 1430 further comprises a role information specification unit 307, an object retrieval unit 308, an object data operation determination unit 309, and an object data operation unit 310. The digital media server 170 comprises a DMS content list 371.

The administration object generation receiving unit 1401 receives an administration object generation command from the unified administration application unit 320, and commands each associated unit for the generation of the object, the setting of each respective type of administration information, and the registration of the object. The global object identification information generation unit 1412 accepts the command from the administration object generation receiving unit 1401, and generates a global identification information that is capable of uniquely identifying an object on the network 120 and that does not depend on a recording position. The global identification information is set in the administration source object and passed to the title information generating/setting unit 1411. The role information generating unit 1404 accepts the command from the administration object generation receiving unit 1401, generates the role information in accordance with the user request, and notifies the title information generating/setting unit 1411. The title information generating/setting unit 1411 generates a title information and sets the title information thus generated to a metadata of the object, in accordance with the global object identification information that is received from the global object identification information generation unit 1412 and the role information that is received from the role information generating unit 1404.

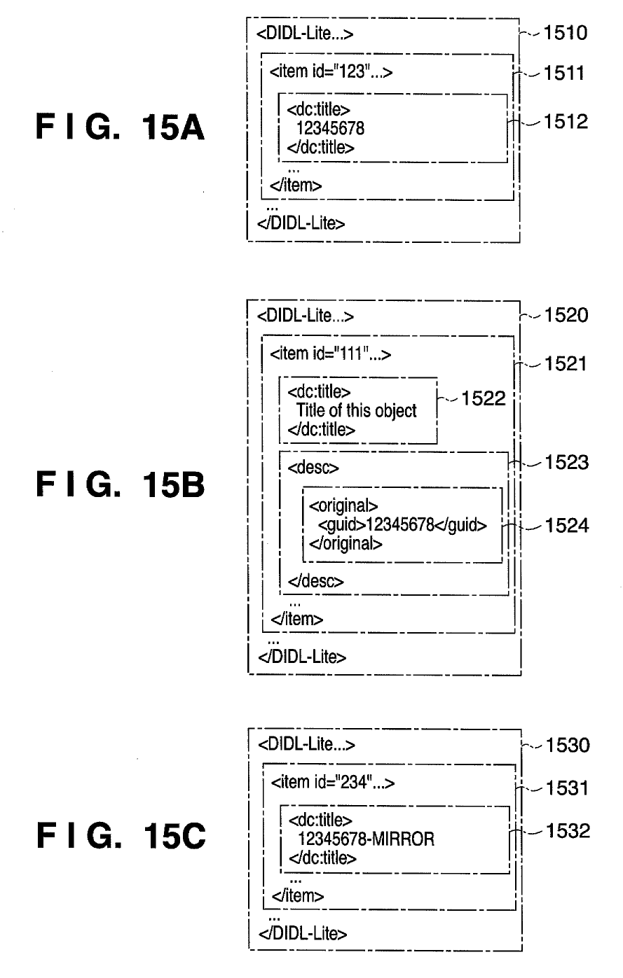

FIGS. 15A-15C depict an example of the metadata of the object according to the third embodiment. As depicted in FIGS. 15A-15C, the metadata of the object is configured of a content list 1510 and 1530 that is within each respective device, and an integrated content list 1520. The content lists are defined in Extensible Markup Language (XML), for example.

The content list 1510 denotes an example wherein a content list DIDL-Lite possesses an administration source object <item> 1511. The administration source object 1511 possesses a title information <dc:title> 1512, for example. In the present circumstance, the title information 1512 is set to a global object identification information 12345678 for uniquely identifying the administration source object 1511 without being dependent upon a save position.

The integrated content list 1520 denotes an example wherein a content list DIDL-Lite possesses a reference object <item> 1521 that denotes a reference of the administration source object 1511. The reference object 1521 possesses a title information <dc:title> 1522 and a user-defined metadata <desc> 1523. The user-defined metadata 1523 incorporates an object identification information <original> 1524 for identifying the administration source object 1511. The object identification information 1524 incorporates a global object identification information <guid>, which is set to “12345678” in the present example.

The content list 1530 denotes an example wherein a content list DIDL-Lite possesses an administration object <item> 1531 that denotes a mirroring of the administration source object 1511. The administration object 1531 possesses a title information <dc:title> 1532. The title information 1532 incorporates a global object identification information for identifying the administration source object 1511, which is set to “12345678” in the present example.

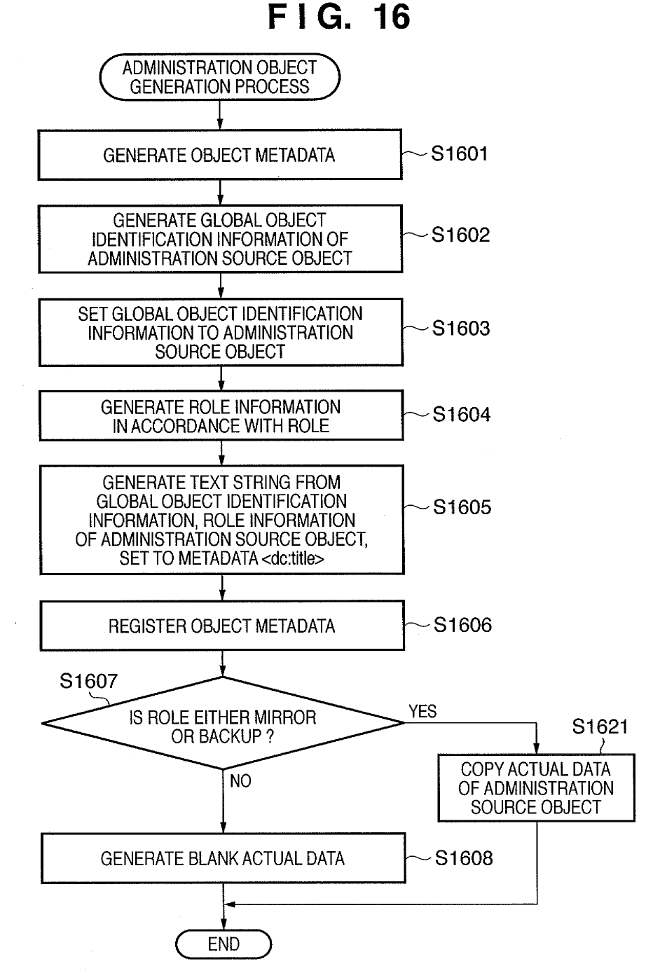

FIG. 16 is a flowchart depicting an administration object generation process, i.e., a process that generates the administration object 1531, according to the third embodiment. The administration object generation process commences in step S511, preceding.

In step S1601, the administration object generation receiving unit 1401 commands the object generation and registration unit 302 to generate the object metadata. The object metadata corresponds to the administration object 1531. In step S1602, the global object identification information generation unit 1412 generates the global object identification information. In step S1603, the global object identification information generation unit 1412 sets the global object identification information thus generated to the metadata <dc:title> of the administration source object.

In step S1604, the role information generating unit 1404 generates the role information in accordance with the role that is user-specified via the user interface that is provided by the unified administration control point 1130. In step S1605, the title information generating/setting unit 1411 generates a text string from the global object identification information and the role information of the administration source object, and sets the text string thus generated to the <dc:title> of the object metadata. In step S1606, the object generation and registration unit 302 registers the object metadata.

In step S1607, the object generation and registration unit 302 verifies whether or not the role is either of the mirroring or the backup. If the role is either of the mirroring or the backup, the process proceeds to step S1621. In step S1621, the object generation and registration unit 302 copies a real data of the administration source object, and terminates the process. If, on the other hand, the role is neither the mirroring nor the backup in step S1607, the process proceeds to step S608. In step S1608, the object generation and registration unit 302 generates a blank actual data, and terminates the process.

According to the third embodiment, the global object identification information that uniquely specifies an object without being dependent upon the apparatus or the content directory service that records the object is generated and set, as the title value, for example, that is within the administration source object. A text string is generated that incorporates the global object identification information and the role information thus generated, and is set as the title information 1532 that is within the administration object. The administration object that comprises the title value that incorporates the global object identification information of the administration source object is acquired in the process that corresponds to each respective administration operation that is depicted in FIGS. 7-10. The process for the administration object that is thus acquired is determined in accordance with the role information, i.e., MIRROR, BACKUP, or JOIN, that is incorporated within the title value.

According to the third embodiment, the global object identification information that is independent of the recording position is assigned to the administration source object, and the administration object is administrated with the global object identification information. The necessity for updating the administration object is thus obviated, even when the administration source object is moved.

### Other Embodiments

The present invention incorporates a circumstance wherein the function of the embodiment is achieved by supplying a software program, either directly or remotely, to a system or an apparatus, and a computer of the system or the apparatus loading and executing the program code thus supplied. In such a circumstance, the program thus supplied corresponds to the flowchart that is depicted in the illustration of the embodiment.

Accordingly, the program code itself that is installed on the computer in order to implement the function process of the present invention upon the computer implements the present invention. The present invention thus incorporates the computer program itself for implement the function process of the present invention.

In such a circumstance, the program may take such a form as an object code, a program that is executed by an interpreter, or a script that is supplied to an operating system, provided that the form comprises a function of a program.

Possible recording media for supplying the program are as follows: such as, for example, a hard disk drive, an optical disk, a magneto-optical (MO) disk, a CD-ROM, a CD-R, a CD-RW, a magnetic tape, a nonvolatile memory card, a ROM, or a DVD (DVD-ROM or DVD-R).

As another method of supplying the program, it would be possible to employ a browser of a client computer to connect to a web page on the Internet and download the computer program of the present invention from the website to a hard disk drive or other recording medium. In such a circumstance, it would be permissible for the program thus downloaded to be a compressed file that incorporates an automatic installation function. It would also be possible to implement the present invention by segmenting the program code that configures the program of the present invention into a plurality of files, and downloading each respective file from a different web page. The web server that downloads the program file for executing the function process of the present invention on the computer to a plurality of users is thus also incorporated within the present invention.

It would also be possible for the program of the present invention to be distributed to a user in a form of being encrypted and stored on a CD-ROM or other storage medium. In such a circumstance, it would be further possible to have a user who satisfies a predetermined condition download a key information from a webpage on the Internet that decrypts the encryption, and to use the key information to execute the program thus encrypted and install the program on the computer.

In addition to the computer executing the program thus loaded, it would be permissible for the function of the embodiment to be implemented in conjunction with an operating system or other software running on the computer, in accordance with the command of the program. In such a circumstance, the function of the embodiment is implemented by an actual process that the operating system or other software performs in whole or in part.

It would be further permissible for the program that is loaded from the recording medium to be written to a memory that an expansion board that is fitted into the computer, or an expansion unit that is connected to the computer, comprises, and for the function of the embodiment to be implemented in whole or in part. In such a circumstance, a CPU or other hardware that the expansion board or the expansion unit comprises performs the actual process, in whole or in part, in accordance with a command of the program.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-005082, filed Jan. 12, 2007, which is hereby incorporated by reference herein in its entirety.

What is claimed is:

1. A method adapted to processing an object data that exists in a network, comprising the steps of:
searching, within the network, for a second object data that corresponds to a first object data and whereto a predetermined data has been added; and
changing the second object data in response to a change on the first object data.

2. The method according to claim 1, wherein the step of searching for the second object data searches for a second object data that corresponds to a first object data that a device that is detected as being connected to the network possesses, and whereto the predetermined data has been added.

3. The method according to claim 1, wherein the step of searching for the second object data searches for a second object data that a device that is detected as being connected to the network possesses.

4. The method according to claim 1, wherein the step of searching for the second object data searches for a second object data that corresponds to the first object data and whereto the predetermined data has been added as a metadata.

5. The method according to claim 1, wherein the step of searching for the second object data searches for a second object data that corresponds to the first object data and whereto the predetermined data has been added in a title thereof.

6. The method according to claim 1, further comprising the step of assigning an identification data to the first object data, and adding to the second object data the identification data that is assigned to the first object data and the predetermined data.

7. An apparatus for processing an object data that exists in a network, comprising:
a unit configured to search, within the network, for a second object data that corresponds to a first object data and whereto a predetermined data has been added; and
a unit configured to change the second object data in response to a change on the first object data.

8. The apparatus according to claim 7, wherein the unit configured to search for the second object data searches for a second object data that corresponds to the first object data that a device that is detected as being connected to the network possesses, and whereto the predetermined data has been added.

9. The apparatus according to claim 7, wherein the unit configured to search for the second object data searches for a second object data that a device that is detected as being connected to the network possesses.

10. A storage medium adapted to storing a computer program adapted to processing an object data that exists in a network, the computer program causing a computer to perform the steps of:
searching, within the network, for a second object data that corresponds to a first object data and whereto a predetermined data has been added; and
changing or deleting the second object data in response to a change on, or a deletion of, the first object data.

11. The storage medium according to claim 10, wherein the step of searching for the second object data searches for a second object data that corresponds to the first object data that a device that is detected as being connected to the network possesses, and whereto the predetermined data has been added.

12. The storage medium according to claim 10, wherein the step of searching for the second object data searches for a second object data that a device that is detected as being connected to the network possesses.

13. A method adapted to processing an object data that exists in a network, comprising the steps of:
searching, within the network, for a second object data that corresponds to a first object data and whereto a predetermined data has been added; and
deleting the second object data in response to a deletion of the first object data.

14. The method according to claim 13, wherein the step of searching for the second object data searches for a second object data that corresponds to the first object data that a device that is detected as being connected to the network possesses, and whereto the predetermined data has been added.

15. The method according to claim 13, wherein the step of searching for the second object data searches for a second object data that a device that is detected as being connected to the network possesses.

16. An apparatus for processing an object data that exists within a network, comprising:
a unit configured to search, within the network, for a second object data that corresponds to a first object data and whereto a predetermined data has been added; and
a unit configured to delete the second object data in response to a deletion of the first object data.

17. The apparatus according to claim 16, wherein the unit configured to search for the second object data searches for a second object data that corresponds to the first object data that a device that is detected as being connected to the network possesses, and whereto the predetermined data has been added.

18. The apparatus according to claim 16, wherein the search unit configured to search for the second object data searches for a second object data that a device that is detected as being connected to the network possesses.
